(19) United States
(12) Patent Application Publication
(10) Pub. No.: US 2026/0166941 A1
(43) Pub. Date: Jun. 18, 2026

(54) AIR DISTRIBUTION OF A HEATING, VENTILATION, AND AIR CONDITIONING UNIT

(71) Applicant: DENSO International America, Inc., Southfield, MI (US)

(72) Inventors: Siyue CHEN, Northville, MI (US); Junxiang SHI, Lake Orion, MI (US)

(73) Assignee: DENSO International America, Inc., Southfield, MI (US)

(21) Appl. No.: 19/418,073

(22) Filed: Dec. 12, 2025

Related U.S. Application Data
(60) Provisional application No. 63/733,011, filed on Dec. 12, 2024.

(51) Int. Cl. B60H 1/00

(52) U.S. Cl. CPC B60H 1/00064; B60H 2001/00092

(57) ABSTRACT

A distribution case of a heating, ventilation, and air conditioning (HVAC) unit including a defrost outlet, a primary demist outlet, a secondary demist outlet, and a defrost door. The primary demist outlet and the secondary demist outlet being separated by and adjacent to the defrost outlet. The defrost outlet having a defrost outlet width separated into a primary and a secondary portion, and the primary and the secondary demist outlet each having a demist outlet width. A case blocker extends from the distribution case into an air flow path to the defrost outlet. A defrost door having door shaft with a primary and a secondary door body extending from the door shaft into the direction of the defrost and the demist outlets. The door bodies having guiding ribs that, in combination of the case blocker, creates an air distribution ratio between the defrost and the primary and secondary demist outlets.

### CROSS-REFERENCE TO RELATED APPLICATIONS

This application claims the benefit of U.S. Provisional Application No. 63/733,011 filed on Dec. 12, 2024. The entire disclosure of the above application is incorporated herein by reference.

### FIELD

The present disclosure relates to air distribution of a heating, ventilating, and air conditioning unit.

### BACKGROUND

This section provides background information related to the present disclosure, which is not necessarily prior art.

Heating, ventilation, and air conditioning (HVAC) units distribute air to specific areas of an automobile passenger cabin depending on the mode the HVAC unit is in. Two specific areas that HVAC units distribute air to are the windshield, in defrost mode, and the driver side and passenger side windows, in demist mode. To distribute air to these specific areas, HVAC units can employ a variety of systems and methods that employ high complexity, require a large packaging space, and have high cost. While current HVAC systems are suitable for their intended use, they are subject to improvement. A simplified, robust, and low packaging space implementation of HVAC air distribution assembly is desirable. Specifically, a HVAC unit that distributes air to the defrost area and the demist area through the use of a single door controlled by a single actuator and HVAC unit geometry is useful and desirable.

### SUMMARY

This section provides a general summary of the disclosure, and is not a comprehensive disclosure of its full scope or all of its features.

According to an aspect of the present disclosure, a distribution assembly comprises a distribution case, a defrost door with a door shaft, a defrost outlet, a primary demist outlet, a secondary demist outlet, and a case blocker. The defrost door is rotatably mounted to the distribution case by the door shaft, and a primary door body and a secondary door body extend from the door shaft into an air flow path. The defrost outlet has a defrost width. The primary demist outlet and the secondary demist each have a demist width. The defrost outlet is divided into a primary defrost portion and a secondary defrost portion, and the primary defrost portion and the secondary defrost porty each have a portioned width. The primary defrost demist outlet and the secondary demist outlet are adjacent to, and separated by, the defrost outlet. The case blocker extends laterally from the distribution case into an air flow path. The case blocker extends laterally from the distribution case to a blocker height and the case blocker has a width that is approximately equal to the defrost width. The primary door body and the secondary door body include a guiding rib extending laterally from a face of each of the primary door body and the secondary door body to a guide rib height. The guiding rib is angled on the face of each of the primary door body and the secondary door body along a guiding rib length from a door body gap that separates the primary door body and the secondary door body toward at least one of the primary demist outlet and the secondary demist outlet.

In another aspect, the primary defrost portion of the defrost outlet and the primary demist outlet is surrounded by a seat area, and the secondary defrost portion of the defrost outlet and the secondary demist outlet is surrounded by another seat area.

In another aspect, the primary door body and the secondary door body each include a door seal, each of the door seals are configured to interface with the seat area and the another seat area.

In another aspect, the primary door body and the second door body are adjacent to each other and planarly parallel to each other.

In another aspect, the defrost door is rotatably mounted to the distribution case at a door mount.

In another aspect, the door shaft of the defrost door includes a first end, a second end, and an intermediate portion disposed between the first end and the second end. A primary door body and a secondary door body extend to a door body length from the intermediate portion of the door shaft into the air flow path designated to the defrost outlet, the primary demist outlet, and the secondary demist outlet. The primary door body and the secondary door body both have a width that is approximately equal to at least one of the primary defrost portion and the secondary defrost portion of the defrost outlet and at least one of the primary demist outlet and the secondary demist outlet combined.

In another aspect, the defrost door is rotatably positioned to be in at least one of a closed position of a zero degree angle, a partial open position of a ten degree angle, another partial open position of a thirty degree angle, and full open position of a forty degree angle.

In another aspect, the defrost door is positioned to be in the closed position, the partial open position, the another partial open position, and the full open position that provides an air distribution ratio between the defrost outlet and the primary demist outlet and the secondary demist outlets.

The distribution assembly further includes, a panel outlet with a panel distribution door, a foot outlet with a foot distribution door, and a rear outlet with a rear distribution door. The defrost door, panel distribution door, the foot distribution door, and the rear distribution door are configured to be opened and closed depending on a mode of the distribution assembly.

In another aspect, the mode of the distribution assembly is at least one of a panel mode, a foot mode, a heat mode, and a defrost mode.

In another aspect, the defrost door is in the closed position in the panel mode, the defrost door is in the partial open position in the foot mode, the defrost door is in the another partial open position in the heat mode, and the defrost door is in the full open position in the defrost mode.

In an aspect of the present disclosure, a heating, ventilation, and air conditioning (HVAC) unit comprises an air intake, a blower assembly, and a distribution assembly. The distribution assembly includes a defrost outlet, a primary demist outlet, a secondary demist outlet, a defrost door, a case blocker, and guiding ribs. The defrost outlet has a defrost width. The defrost outlet is portioned into a primary defrost portion and a secondary defrost portion. The primary demist outlet and the secondary demist outlet each have a demist width. The demist width of the primary demist outlet in combination with a width of the primary defrost portion creates a primary portion width. The demist width of the secondary demist outlet in combination with another width of the secondary defrost portion creates a secondary portion width. The defrost door includes a door shaft, a primary door body, and a secondary door body. The door shaft is rotatably mounted to the distribution assembly, the primary door body having a primary door body width that is approximately equal to the primary portion width, the secondary door body having a secondary door body width that is approximately equal to the secondary portion width, and the primary door body and the second door body each extend laterally from the door shaft to a door body length. The case blocker extends in a direction of the air flow path before the defrost outlet to a blocker height. The case blocker has a blocker width that is approximately equal to the primary defrost outlet width and the secondary defrost outlet width combined. The guiding ribs extend from a face of each of the primary door body and the secondary door body to a guiding rib height. The guiding ribs have a guiding rib length across a portion of each of the primary door body and the secondary door body that is angled from a door body gap that separates the primary door body from the secondary door body to at least one of the primary demist outlet and the secondary demist outlet.

In another aspect, the defrost door is rotatably positioned to be in at least one of a closed position of a zero degree angle, a partial open position of a ten degree angle, another partial open position of a thirty degree angle, and full open position of a forty degree angle.

In another aspect, the defrost door is positioned to be in the closed position, the partial open position, the another partial open position, and the full open position providing an air distribution ratio between the defrost outlet and the primary demist outlet and the secondary demist outlets.

The HVAC unit further includes a panel outlet with a panel distribution door in the distribution assembly, a foot outlet with a foot distribution door in the distribution assembly, and a rear outlet with a rear distribution door in the distribution assembly. The defrost door, the panel distribution door, the foot distribution door, and the rear distribution door are configured to be opened and closed depending on a mode of the distribution assembly.

In another aspect, the defrost door is in the closed position in a panel mode, the defrost door is in the partial open position in a foot mode, the defrost door is in the another partial open position in a heat mode, and the defrost door is in the full open position in a defrost mode.

According to an aspect of the present disclosure, a heating, ventilation, and air conditioning (HVAC) comprises an air intake, a blower assembly, and a distribution assembly. The blower assembly is configured to create an air flow path by a blower motor with a fan, the air flow path beginning at the air intake and flowing to the blower assembly. The distribution assembly is configured to receive the air along the air flow path after the blower assembly. The distribution assembly includes a plurality of distribution apertures, a defrost door, a case blocker, and guiding ribs. The plurality of distribution apertures includes a defrost outlet, a primary demist outlet, and a secondary demist outlet. The defrost outlet has a primary defrost outlet width and a secondary defrost outlet width. The primary demist outlet has a primary demist outlet width. The primary demist outlet is adjacent to the defrost outlet and in combination with the primary defrost outlet width creating a primary width. The secondary demist outlet has a secondary demist width. The secondary demist outlet is adjacent to the defrost outlet and in combination with the secondary defrost outlet width creating a secondary width. The defrost door has a door shaft, a primary door body, and a secondary door body. The door shaft is rotatably mounted to the distribution assembly. The primary door body and the secondary door body extend to a door body length from the door shaft in the direction of the defrost outlet and the primary demist outlet and the secondary demist outlet. The case blocker extends in a direction of the air flow path before the defrost outlet. The case blocker extends to a blocker height. The case blocker has a blocker width that is approximately equal to the primary defrost outlet width and the secondary defrost outlet width combined. The guiding ribs extend to a guiding rib height from a face of each of the primary door body and the secondary door body. The guiding ribs have a guiding rib length along the face of each of the primary door body and the secondary door body at an angle from the door body gap to at least one of the primary demist outlet and the secondary demist outlet. The defrost door is configured to be positioned at an angle by the door shaft. The case blocker and the guiding ribs of the primary door body and the secondary door body create an air distribution ratio of the air along the air flow path between the defrost outlet and the primary demist outlet and the secondary demist outlet.

The HVAC unit further includes a panel outlet with a panel distribution door in the distribution assembly, a foot outlet with a foot distribution door in the distribution assembly, and a rear outlet with a rear distribution door in the distribution assembly. The defrost door, the panel distribution door, the foot distribution door, and the rear distribution door are configured to be opened and closed depending on a mode of the distribution assembly.

In another aspect, the mode of the distribution assembly is at least one of a panel mode, a foot mode, a heat mode, and a defrost mode.

In another aspect, the defrost door is in a closed position at an angle of approximately zero degrees in the panel mode, the defrost door is in a partial open position at an angle of approximately ten degrees in the foot mode, the defrost door is in another partial open position at an angle of approximately thirty degrees in the heat mode, and the defrost door is in a full open position at an angle of approximately forty degrees in the defrost mode.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIGS. 1A and 1B illustrate perspective views of an example heating, ventilation, and air conditioning (HVAC) unit;

FIG. 2 illustrates a side view of an example HVAC unit;

FIGS. 3A and 3B illustrate cross-sectional side views of an air intake assembly of a HVAC unit;

FIG. 4 illustrates a top cross-sectional view of an air intake and a blower assembly of a HVAC unit;

FIG. 5 illustrates a perspective view of a defrost door;

FIGS. 6A and 6B illustrate a top view of a defrost outlet and demist outlets and a front view of a distribution assembly with a case blocker, respectively;

FIGS. 7A and 7B illustrate a cross-sectional view of an example distribution assembly and a close-up view of the defrost door position in panel mode;

FIGS. 8A and 8B illustrate a cross-sectional view of an example distribution assembly and a close-up view of the defrost door position in defrost mode;

FIGS. 9A and 9B illustrate a cross-sectional view of an example distribution assembly and a close-up view of the defrost door position in foot mode; and

FIGS. 10A and 10B illustrate a cross-sectional view of an example distribution assembly and a close-up view of the defrost door position in heat mode.

Corresponding reference numerals indicate corresponding parts throughout the several views of the drawings.

### DETAILED DESCRIPTION

Example embodiments will now be described more fully with reference to the accompanying drawings.

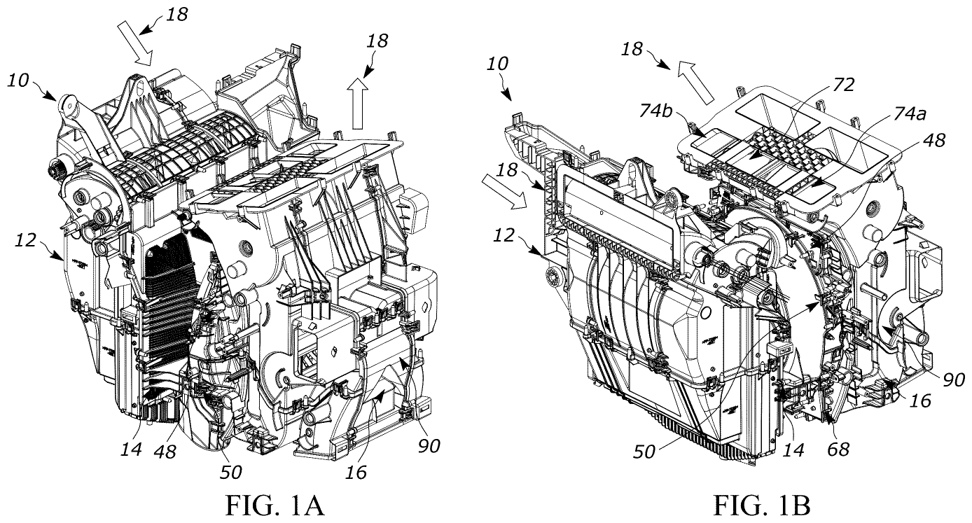

With reference to FIGS. 1A and 1B, an example heating, ventilation, and air conditioning (HVAC) unit 10 is shown. The HVAC unit 10 can be useful for heating and cooling air while also distributing air to multiple zones of a vehicle passenger cabin, for example the windshield, driver-side and passenger-side windows, the feet of vehicle occupants, and the head (e.g. bodies, torsos, etc.) of vehicle occupants. The HVAC unit 10 can be placed in modes that determine the air distribution to the zones and whether air is being drawn from a fresh air source outside the vehicle or being drawn from a source inside of the vehicle, which will be described in further detail below. The HVAC unit 10 can also distribute air to the multiple different zones at the same time through a mixed mode.

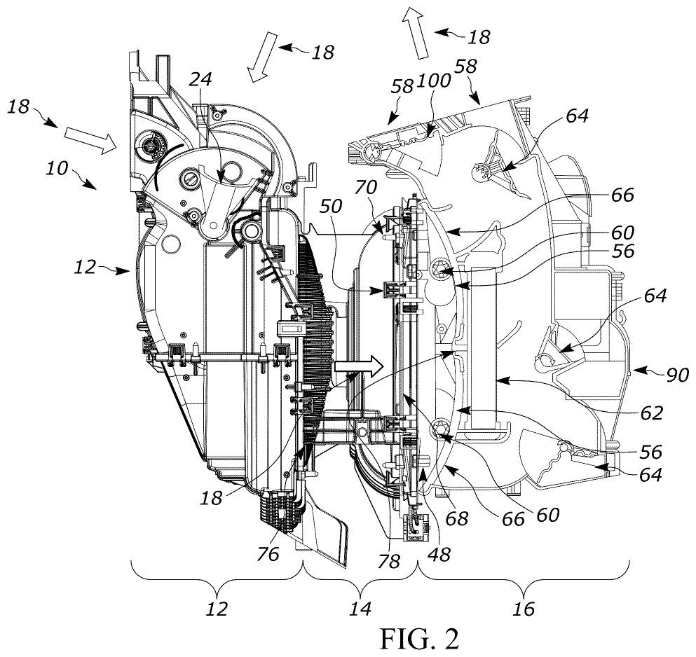

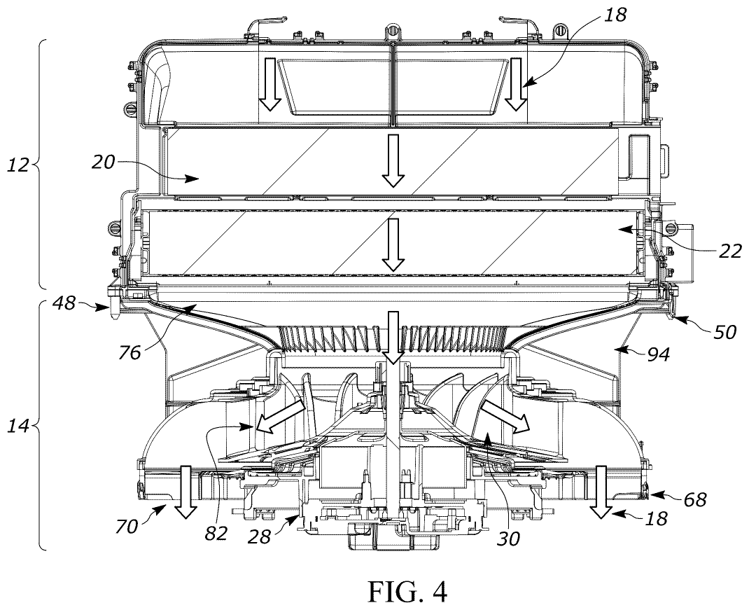

With additional reference to FIG. 2, the HVAC unit 10 can include an air intake assembly (e.g. air inlet, fresh/recirculation assembly, etc.) 12, a blower assembly (e.g. blower, fan assembly) 14, and a distribution assembly (e.g. distribution, distributor) 16. The HVAC unit 10 can create an air flow path 18. The air flow path 18 can be generated by a blower motor 28 with a fan 30, as shown in FIG. 4, that can draw in air through the air intake 12 and flow (e.g. expel, push) the air through the subsequent (e.g. downstream) blower assembly 14 and distribution assembly 16.

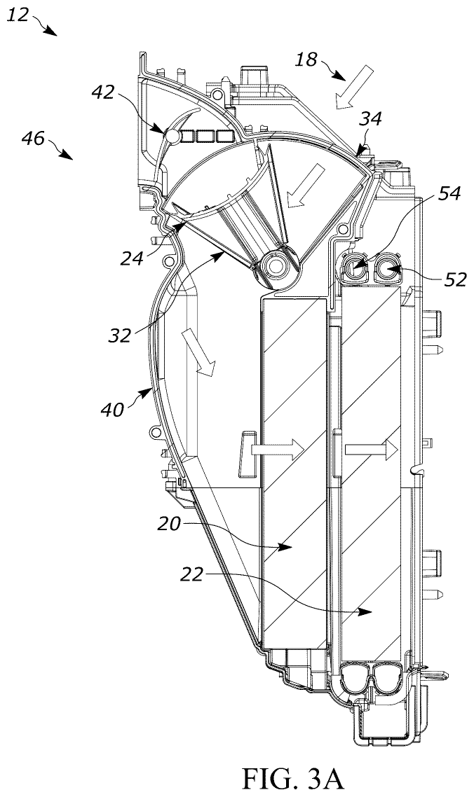

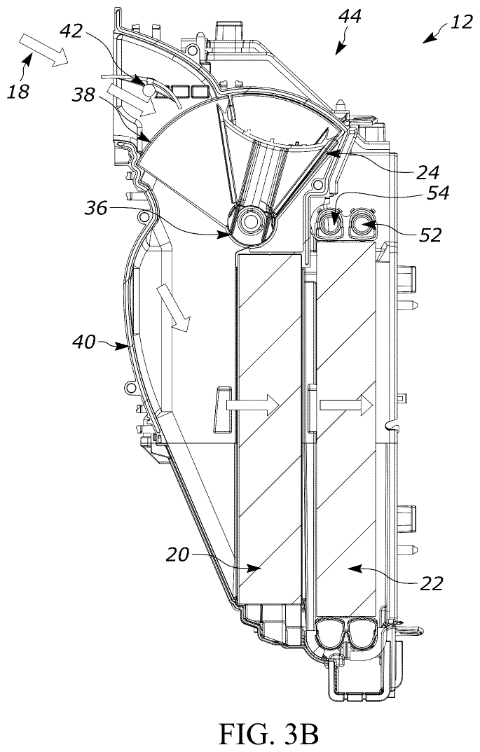

As shown in FIGS. 3A, 3B, and 4, the air intake assembly 12 can include an air intake shell 40, a filter 20, an evaporator 22, and an inlet door 24. The air flow path 18 begins at the air intake 12 when the blower motor 28 is engaged. The air intake shell 40 can house and mount the filter 20, the evaporator 22, and the inlet door 24. Based on the position of the inlet door 24, the air intake assembly 12 can be placed in a fresh mode 44, as shown in FIG. 3B, and a recirculation mode 46, as shown in FIG. 3A.

With reference to FIG. 3A, the recirculation mode 46 can be provided when the inlet door 24 is placed in a recirculation position (e.g. recirc position) 32 by an actuator (not shown), which results in a recirculation aperture (e.g. recirc aperture) 34 being open. The recirculation aperture 34 can allow air to be drawn by the blower motor 28 that has previously flowed through the HVAC unit 10 and enclosed space of the vehicle (not shown) via a series of ducts (not shown).

As shown in FIG. 3B, the fresh mode 44 is provided when the inlet door 24 is placed in a fresh position 36 by the actuator (not shown), which results in a fresh aperture 38 being open. The fresh aperture 38 can allow air to be drawn by the blower motor 28 when engaged that is available outside of the HVAC unit 10 and outside the enclosed space, which can allow air to flow through the HVAC unit 10 for the first time. The inlet door 24 can include an inlet door seal to abate either fresh or recirculated air from entering the HVAC unit 10 when not in the respective mode.

The inlet door 24 is illustrated as a rotary door in FIGS. 3A and 3B, but it is contemplated the inlet door 24 can alternatively be a flag door, or a film door (e.g. rack and pinion door), or another suitable door to place the air intake assembly 12 into the fresh mode 44 or recirculation mode 46. A flag door and a film door are described in additional detail below. A fresh intake door 42 can also be provided inside the fresh aperture 38 that pivots between recirculation and fresh modes. The fresh intake door 42 is open in fresh mode 44 and closed in recirculation mode 46. While closed, the fresh intake door 42 can provide additional air restriction along the air flow path 18 prior to the inlet door 24.

Continuing with FIGS. 3A and 3B, the air intake assembly 12 can include the filter 20 and the evaporator 22. The filter 20 and the evaporator 22 can be seated inside the air inlet 12 and along the air flow path 18. The filter 20 can be a porous material that may remove air particulates from the air along the air flow path 18 that flows through it. The filter 20 can be encapsulated by the air intake shell 40 and an inlet filter door (not shown) attached to the air intake shell 40, the inlet filter door can provide access to and removability of the filter 20 when it is determined the filter 20 is not providing requisite air flow or other damage that may have occurred requiring replacement of the filter.

The evaporator 22 can be a generally rectangular heat exchanging device comprised of tubes (not shown) and fins (not shown) that allows air of the air flow path 18 to pass through. The evaporator 22 can provide heat absorption to the air of the air flow path 18, and the air of the air flow path 18 can be transformed by the evaporator 22 due to the evaporator 22 removing excess humidity and cooling the air as it passes through. The evaporator 22 may provide the air of the air flow path 18, being drawn by the blower motor 28 with the fan 30, to enter the subsequent assemblies of the HVAC unit 10 with the same (generally equal) humidity level and temperature. The evaporator 22 may allow a fluid, typically refrigerant, to flow through the evaporator tubes 52, 54 that extend through the air intake shell 40. It is contemplated that the evaporator 22 can be in another location of the HVAC unit 10, for example along the air flow path 18 after the blower motor 18 inside the air distribution assembly 16.

As shown in FIG. 4, the air intake 12 can be removably mounted to the blower assembly 14. The air intake 12 can be removably mounted by fasteners 48 and plastic snaps 50 extending from either the air intake 12 or the blower assembly 14 and connected to the other assembly. By mounting of the air intake 12 to the blower assembly 14, and with the blower motor 28 being engaged, the air of the air flow path 18 is drawn through either the fresh aperture 38 or the recirculation aperture 34 of the air intake 12, depending on the position of the inlet door 24, and the air of the air flow path 18 is also drawn through the filter 20 and the evaporator 22.

The blower assembly 14 can include the blower motor 28 with the fan 30 and a blower case 94. The fan 30 of the blower motor 28 can be a centrifugal fan or a turbo fan with fan blades 82. The blower motor 28 can be turned on and off (e.g., engaged and disengaged, activated and deactivated) by a power source (not shown) to cycle air along the air flow path 18 through the HVAC unit 10 when on, or not cycle air through the HVAC unit 10 when off. The blower motor 28 with the fan 30, when engaged, can generate a negative pressure difference between the air intake 12 and an air source. The air source can be either the fresh outside air or the enclosed space air, depending on the position of the inlet door 24, as explained above. The negative pressure difference that is generated allows air to be drawn into the air intake 12 to follow the air flow path 18 through the blower assembly 14 to the distribution assembly 16.

As shown in FIGS. 2 and 4, the blower motor 28 with the fan 30 can draw in air along the air flow path 18 to an intake end 76 of the blower assembly 14 and expel the air through a honeycomb plate 68 at the distribution end 70 of the blower assembly 14. The blower motor 28 with the fan 30 can be placed in a variety of different modes when engaged, ranging from providing a minimal amount of air flow along the air flow path 18 to providing a maximum amount of air flow along the air flow path 18 through the HVAC unit 10. The variety of different modes of the blower motor 28 can be characterized by how fast the fan 30 is spinning and how much power is being drawn from the power source. The honeycomb plate 68 can be connected to the distribution assembly 16 by fasteners 48 and plastic snaps 50, and the air can flow from the blower assembly 14 to the distribution assembly 16 through the honeycomb plate 68. The honeycomb plate 68 can also mount the blower motor 28 to the blower assembly 14.

With reference to FIGS. 1A, 1B, 2, and 7A, the distribution assembly 12 can include a distribution case 90, a heater core 62, a blend door 66, a plurality of distribution apertures 58, a defrost door 100, and a plurality of distribution doors 64. The distribution assembly 16 is useful for distributing air to a variety of zones of a vehicle cabin (not shown). The distribution assembly 16 is generally symmetrical and can receive the air expelled by the blower assembly 14 and distribute the air to the plurality of distribution apertures 58. The amount of air going to each of the distribution apertures 58 can be determined by the mode of the blower motor 28 with the fan 30, the position of the distribution doors 64, the position of the defrost door 100, and distribution assembly 16 geometry, which will be described in detail below.

With reference to FIGS. 2, 7A, 8A, 9A, and 10A, the heater core 62 is similar in structure to the evaporator 22, having tubes and fins that the air of the air flow path 18 may pass through, but differs by providing heat instead of removing heat from the air as it passes through. The blend door 66 may determine the amount of air along the air flow path 18 that passes through the heater core 62, thus allowing the temperature of the air passing through the distribution assembly 16 along the air flow path 18 to be determined to be hotter or colder depending on the position of the blend door 66.

The blend door 66 is shown as being two film doors (e.g. rack and pinion doors, barn doors). The blend door 66, being two film doors, can have a rack 56 and a pinion 60 for each of the two film doors. The pinion 60 can be rotated by an actuator (not shown) which drives the rack 56 meshed with the associated pinion 60. The air of the air flow path 18 can be distributed by the blend door 66 to have one hundred percent of the air pass through the heater core 62, the blend door 66 can be positioned to have zero percent of the air to pass through the heater core 62, or the blend door 66 can be positioned to have any other percentage of air between one hundred and zero to pass through the heater core 62.

When the blend door 66 is in the position to have zero percent of the air along the air flow path 18 to pass through, the two racks 56 of the film doors converge to a blend door seat 78 extending from the distribution case 90 into the air flow path 18 that can allow the racks 56 to interface with to inhibit air to pass to the heater core 62. It is contemplated that the blend door 66 can be another suitable door configured to provide a percentage of air between one hundred percent and zero percent to the heater core 62, for example a flag door or a rotatory door.

The air along the air flow path 18, whether passing through the heater core 62 or not, enters either an upper zone 84 or a lower zone 86 of the distribution assembly 16. The upper zone 84 is characterized as being surrounded by the distribution case 90 and allowing the air to be expelled to the distribution apertures 58 including a defrost outlet 72, two demist outlets (e.g. primary and secondary demist outlets, driver side and passenger side outlets) 74 separated by and adjacent to the defrost outlet 72, and a panel outlet (e.g. face outlet) 88. The primary demist outlet 74a is adjacent to a primary portion of the defrost outlet 72 and the secondary demist outlet 74b is adjacent to a secondary portion of the defrost outlet 72, which will be described in detail below. The lower zone 84 is characterized as being surrounded by the distribution case 90 and allowing the air to be expelled to the distribution apertures 58 including a foot outlet (e.g. floor outlet) 92 and a rear outlet 96.

Each distribution aperture 58 has an associated distribution door 64 that can be in either an open position, a closed position, or another position between open and closed. Each distribution door 64 also has associated seat areas 104, similar to the blend door seat 78, for a seal of each of the distribution doors 64 to interface with. The interfacing of the distribution door 64 with the respective seat area 104 abates air from passing through the associated distribution aperture 58 when the distribution door 64 is in the closed position.

The panel outlet 88 has a panel distribution door 98. The foot outlet 92 has a foot distribution door 102. The rear outlet 96 has a rear distribution door 106. The foot distribution door 102, when closed, provides a mixing point between the upper zone 84 and the lower zone 86 of the distribution case 90. The defrost outlet 72 and the two demist outlets 74 share the single defrost door 100, which will be explained in further detail below. The foot distribution door 102 and the panel distribution door 98 are illustrated as rotary doors, and the rear distribution door 106 is illustrated as a flag door, but it is contemplated that the doors 98, 102, 106 can be another suitable door like a flag door, a rotary door, or a film door.

Similar to the blend door 66, each distribution door 64 associated with the distribution apertures 58 is connected to an actuator (not shown) that drives the door into a position that either allows air along the airflow path 18 to be expelled from the associated distribution aperture 58 or to another distribution aperture 58, depending on the mode of the distribution assembly 16. The actuator for each associated distribution door 64 can place the distribution assembly 16 into a variety of modes for air distribution. The modes can include a panel mode 110, a defrost mode 112, a foot mode 114, and a heat mode 116, which will be described in further detail below.

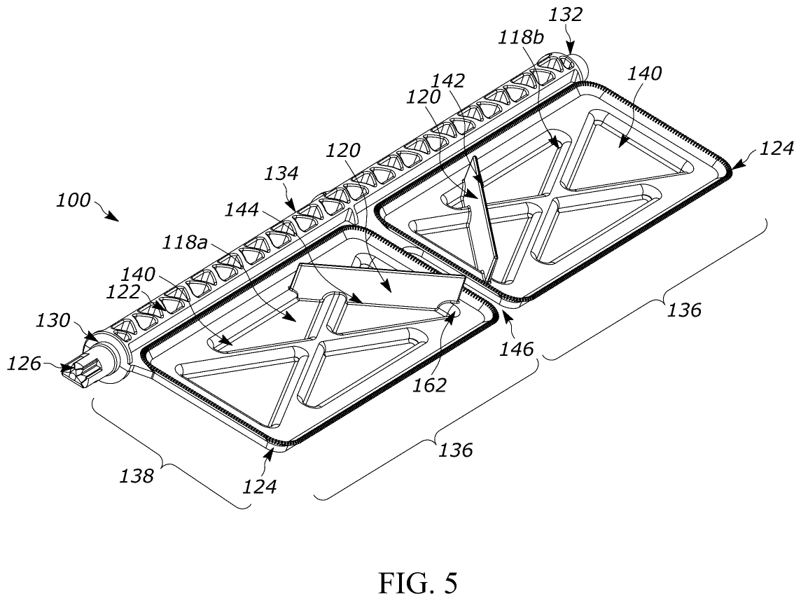

FIGS. 5, 6A, and 7A illustrate the defrost door 100. The defrost door 100 is useful for distributing air along the air flow path 18 between the defrost outlet 72 and the demist outlets 74. The defrost door 100 can include door bodies 118, guiding ribs 120, a door shaft 122, and door seals 124. The defrost door 100 can be rotatably mounted to a door mount 148 inside the distribution case 90 by the door shaft 122. The door shaft 122 can be a cylindrical shape with a first end 130, a second end 132, and an intermediate portion 134 disposed between the two ends 130,132. The door shaft 122 is rotatably mounted at the first end 130 and the second end 132 inside the door mount 148 of the distribution case 90 that is similarly cylindrical to the intermediate portion 134. At the first end 130 of door shaft 122, an actuator mate 126 can extend along an axis 128 of the door shaft 122 and through the distribution case 90 where it is configured to interface with an actuator (not shown) that can adjust an angular position (e.g. defrost angle, angle) 160 of the defrost door 100.

The door bodies 118 extend from the intermediate portion 134 of the door shaft 122 into the air flow path 18 of the defrost outlet 72 and the demist outlets 74. There is a primary door body 118a that is configured to cover a driver side portion 154 of the defrost outlet 72 and the primary demist outlet 74a, and there is a secondary door body 118b that is configured to cover a passenger side portion 156 of the defrost outlet 72 and the secondary demist outlet 74b. The door bodies 118 are generally rectangular and include a door body width 136 and a door body length 138. The door bodies 118 can be planarly parallel to each other. The distance the door bodies 118 extend from the intermediate portion 134 of the door shaft 122 is the door body length 138. The door body length 138 can be a distance from the door shaft 122 to the seating area 104 of the defrost door 100. The door body width 136 can be wider than a portion of the defrost width 150 and one of the demist widths 152, which will be described in further detail below. Surrounding the generally rectangular shape of the door bodies 118 extending from the door shaft 122 are the door seals 124. By rotating the door shaft 122 to be at the angle 160 of zero degrees, resulting in the defrost door 100 being in a closed position, the door seal 124 can interface with the seat area 104 of the defrost door 100.

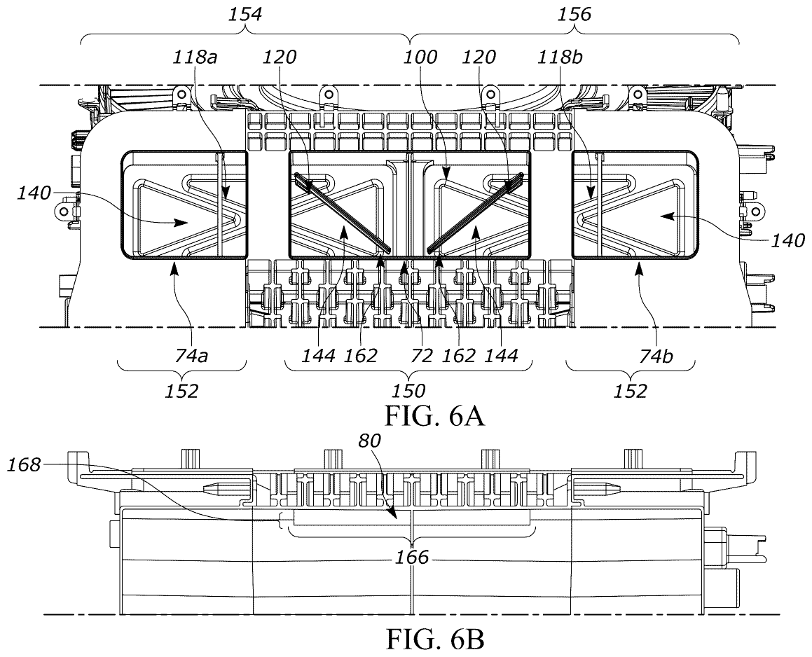

The guiding ribs 120 extend laterally from a face 140 of the door bodies 118 in the direction of the air flow path 18. The guiding ribs 120 can be generally rectangular with a rib height 142 and a rib length 144, where the rib height 142 is the distance the guiding rib 120 extends laterally from the face of the respective door body 118. As shown in FIGS. 5 and 6A, the guiding rib 120 can have a guide rib angle 162 along the rib length 144. The rib length 144 extends from a portion of the door body 118 from a position distal to the door shaft 122 toward the door shaft 122 at the guide rib angle 162. The guide rib angle 162 of the rib length 144 can be from a door body gap 146 that separates the door bodies 118 toward the demist outlets 74. The guiding ribs 120 can assist the singular defrost door 100 in distributing air along the airflow path 18 in a variety of ratios to the defrost outlet 72 and the demist outlet 74 when the defrost door 100 is in an open position, which will be described in more detail below.

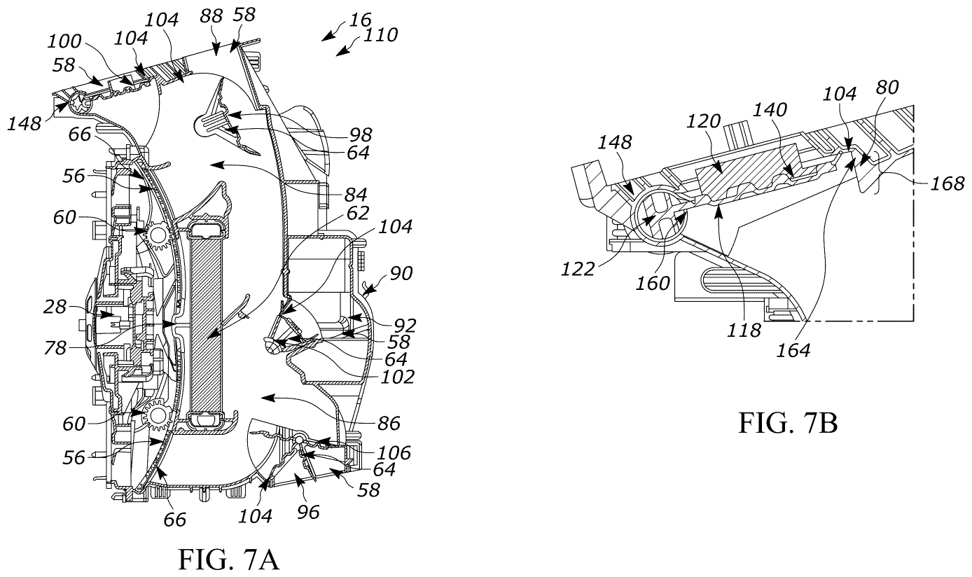

As shown in FIGS. 6A, 6B, and 7B the distribution case 90 includes the defrost outlet 72, the demist outlets 74, and a case blocker 80 that extends from the distribution case 90 into the air flow path 18 at the defrost outlet 72. The defrost outlet 72 has a defrost width 150. The demist outlets 74 have demist widths 152. The door mount 148 that can rotatably mount the door shaft 122 of the defrost door 100 can have a width that spans widths 150, 152 of the defrost outlet 72 and the demist outlets 74. The door shaft 122 can also span the widths 150, 152 which can provide that the door bodies 118 of the defrost door 100 can completely close the defrost outlet 72 and the demist outlets 74 when the defrost door 100 is rotated to a closed position.

As shown in FIG. 6A, the defrost outlet 72 and the demist outlets 74a, 74b are separated into two portions, the driver side portion (e.g. primary portion) 154 and the passenger side portion (e.g. secondary portion) 156. The defrost outlet 72 is divided into the driver side portion 154 and a passenger side portion 156 at the middle of the defrost width 150. The door bodies 118 of the defrost door 100 are separated by the door body gap 146 to cover the two regions 154, 156 when the defrost door 100 is in the closed position. The portions 154, 156 create two portions of the defrost outlet 72, one portion in the driver side portion 154 and the other portion in the passenger side portion 156. As mentioned above, each of the door bodies 118 can have a door body width 136 that is approximately equal to the demist width 152 plus the defrost width 150 of the respective portion 154, 156. Each of the door bodies 118 can also have the door body length 138 that is approximately equal to the distance between the door shaft 122 and the seat area 104 across from the door shaft 122 of the defrost door 100.

The door body width 136 and the door body length 138 allows for complete coverage of the defrost outlet 72 and the demist outlets 74a, 74b for both portions 154, 156. The guiding ribs 120, being angled along the door bodies 118 of the defrost doors 100 from the door body gap 146 toward the demist outlets 74, can push air that would be distributed from the defrost outlet 72 toward the demist outlets 74 when the defrost door 100 is in an open position. The guiding ribs 120 in each portion 154, 156 angles from the door body gap 146 toward either the driver side demist outlet 74a or the passenger side demist outlet 74b depending if the door body 118 the guiding rib 120 extends from is in the driver side portion 154 or the passenger side portion 156.

The case blocker 80 is located at a blocker position 164 which is opposite the door mount 148 across from the defrost outlet 72. The case blocker can include a blocker width 166 and a blocker height 168. The case blocker 80 can work in tandem with guiding ribs 120 of the defrost door 100 to create an air distribution ratio between the defrost outlet 72 and the demist outlets 74 when the defrost door 100 is in an open and a partial open condition. The blocker width 166 can be generally equal to the defrost width 150, allowing the case blocker 80 to extend from the distribution case 90 into the air flow path 18 headed to the defrost outlet 72 in both the driver side region 154 and the passenger side region 156. The blocker height 168 is the distance the case blocker 80 extends laterally from the distribution case 90 into the air flow path 18.

As described above, the defrost door 100 can be placed in a variety of positions. The defrost door 100 with the guiding ribs 120 placed at angles 160 ranging from zero degrees, resulting in a full closed position, to forty degrees (+/−two and one half degrees), resulting in a full open position. The angle 160 of the defrost door 100, along with the case blocker 80, the guiding ribs 120, the defrost width 150, and the demist widths 152, can determine an air flow distribution ratio of the air along the air flow path 18 between the defrost outlet and demist outlets 74 for each mode.

FIGS. 7A and 7B illustrate the distribution assembly 16 in a panel mode 110. The panel mode 110 is characterized by the panel distribution door 98 being completely open, which can allow maximum airflow to be expelled from the panel outlet 88. The defrost door 100 and the foot distribution door 102 may be completely closed in panel mode 110. The defrost door 100 being at the angle 160 of zero, or completely closed, can provide for there being no air flow distribution ratio between the defrost outlet 72 and the demist outlets 74. The rear distribution door 106 may be fully closed, fully open, or in another position between fully closed and fully open depending on whether the panel mode 110 is in a mode for front passengers of the vehicle cabin or for front passengers and rear passengers of the vehicle cabin.

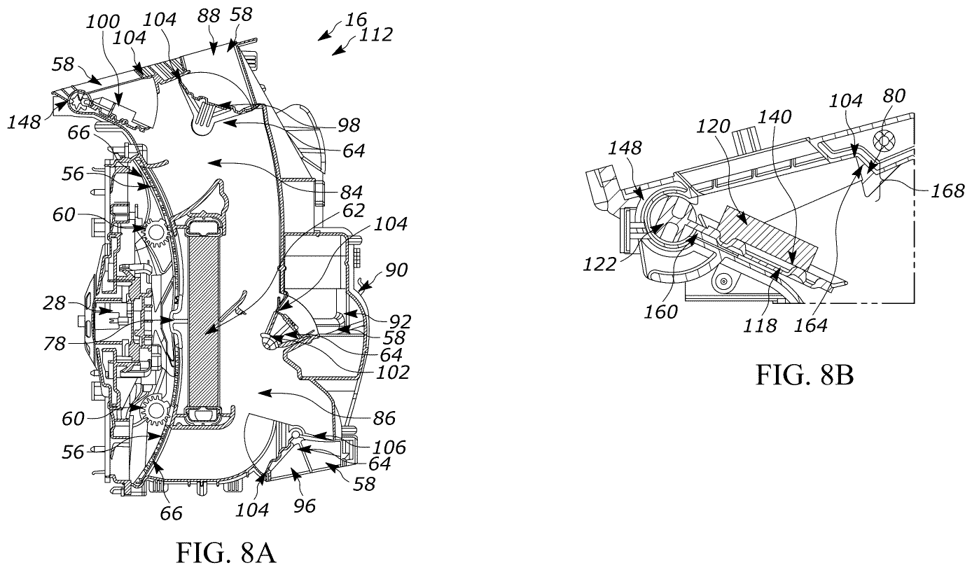

FIGS. 8A and 8B illustrate the distribution assembly 16 in a defrost mode 112. Defrost mode 112 is characterized by the defrost door 100 in an open position that is at an angle 160a forty degrees (+/−two and one half degrees) from the seat area 104 associated with the defrost door 100. Maximum airflow can be expelled from the defrost outlet 72 and the demist outlets 72 in defrost mode 112. The guiding ribs 120, the case blocker 80, and the angle 160a of the defrost door 100 allows an air distribution ratio of 4 (+/−0.1 air flow distribution ratio) between the defrost outlet 72 and the demist outlet 74. The panel distribution door 98 is completely closed, the rear distribution door 106 is completely closed, and the foot distribution door 102 is completely closed.

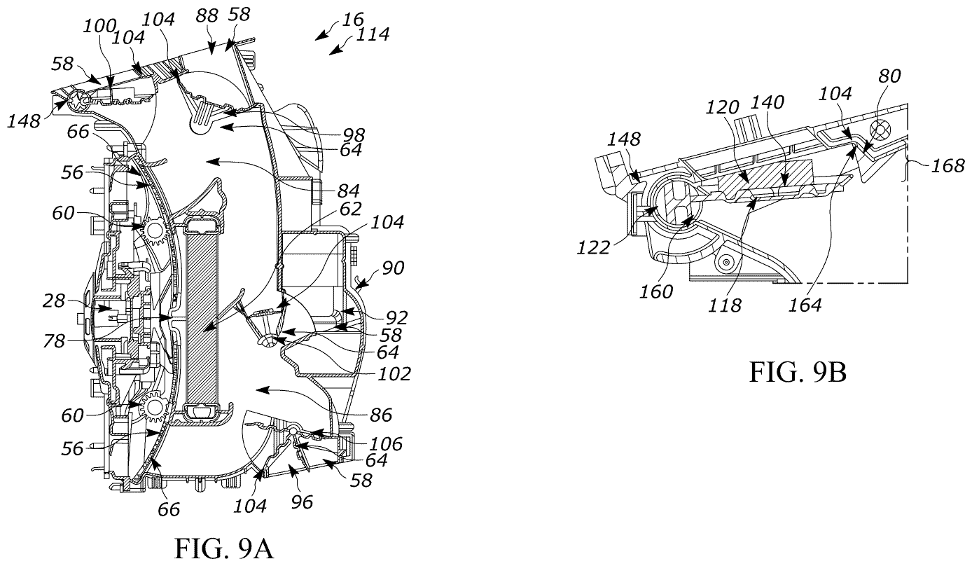

FIGS. 9A and 9B illustrate the distribution assembly 16 in a foot mode 114. Foot mode 114 is characterized by the foot distribution door 102 being completely open, allowing maximum airflow to be expelled through the foot outlet 92, and the defrost door 100 being in an open position that is at an angle 160b ten degrees (+/−two and one half degrees) from the seat area 104 associated with the defrost door 100. In foot mode 114, the case blocker 80 interacts with the angle 160b of the defrost door 100 to limit the air flow path 18 from being expelled from the defrost outlet 72 and demist outlets 74 more than is desired in this mode. The guiding ribs 120 of the defrost door 100 also prevent the air along the air flow path 18 that is allowed to exit the defrost outlet 72 and the demist outlets 72 in this mode from completely exiting the defrost outlet 72, creating an air flow distribution ratio of 1.2 (+/−0.1 air flow distribution ratio) between the defrost outlet 72 and the demist outlets 74. The panel distribution door 98 is completely closed in foot mode 114. The rear distribution door 106 may be fully closed, fully open, or another position between fully closed and fully open depending on whether the foot mode 114 is in a mode for front passengers of the vehicle cabin or for front passengers and rear passengers of the vehicle cabin.

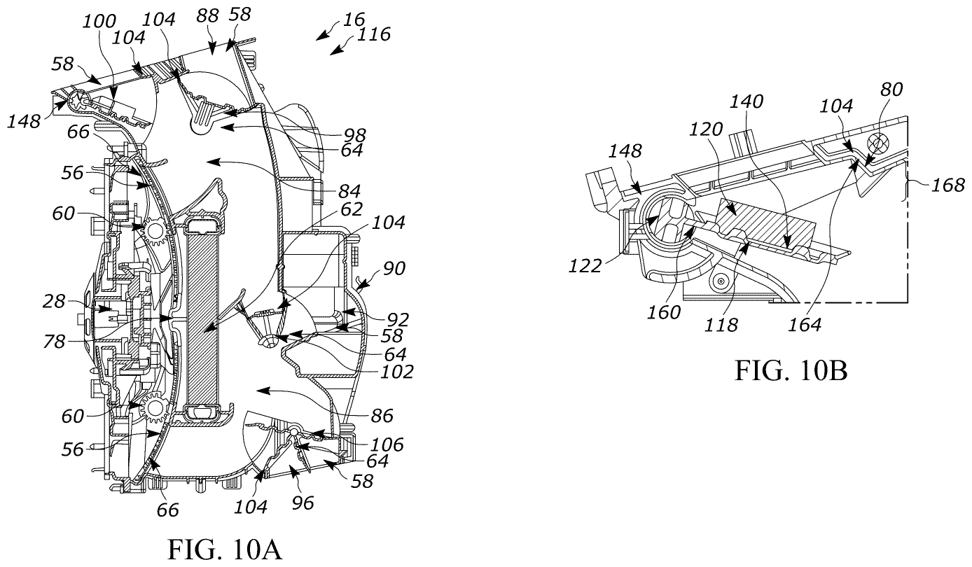

FIGS. 10A and 10B illustrate the distribution assembly 16 in a heat mode 116. Heat mode 116 is characterized by the foot distribution door 102 being completely open, and the defrost door 100 being in an open position that is at an angle 160c thirty degrees (+/−two and one half degrees) from the seat area 104 associated with the defrost door 100. In heat mode 116, the case blocker 80 interacts with the angle 160c of the defrost door 100 to limit the air flow path 18 from being expelled from the defrost outlet 72 and demist outlets 74 more than is desired in this mode. The guiding ribs 120 of the defrost door 100 also prevent the air along the air flow path 18 that is allowed to exit the defrost outlet 72 and the demist outlets 72 in this mode from completely exiting the defrost outlet 72, creating the air flow distribution ratio of 2 (+/−0.1 air flow distribution ratio) between the defrost outlet 72 and the demist outlets 74. The panel distribution door 98 is completely closed in heat mode 116. The rear distribution door 106 may be fully closed, fully open, or another position between fully closed and fully open depending on whether the heat mode 116 is in a mode for front passengers of the vehicle cabin or for front passengers and rear passengers of the vehicle cabin.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A distribution assembly comprising:
a distribution case;
a defrost door that is rotatably mounted to the distribution case by a door shaft, a primary door body and a secondary door body extend from the door shaft into an air flow path;
a defrost outlet, a primary demist outlet, a secondary demist outlet, the defrost outlet having a defrost width, the primary demist outlet and the secondary demist outlet each having a demist width, the defrost outlet being divided into a primary defrost portion and a secondary defrost portion, the primary defrost portion and the secondary defrost portion each having a portioned width, and the primary demist outlet and the secondary demist outlet being adjacent to, and separated by, the defrost outlet; and
a case blocker extending laterally from the distribution case into the air flow path to the defrost outlet, the case blocker extending laterally from the distribution case to a blocker height and the case blocker having a blocker width that is approximately equal to the defrost width;
wherein the primary door body and the secondary door body include a guiding rib extending laterally from a face of each of the primary door body and the secondary door body to a guide rib height, the guiding rib is angled on the face of each of the primary door body and the secondary door body along a guiding rib length from a door body gap that separates the primary door body and the secondary door body toward at least one of the primary demist outlet and the secondary demist.

2. The distribution assembly of claim 1, wherein the primary defrost portion of the defrost outlet and the primary demist outlet is surrounded by a seat area and the secondary defrost portion of the defrost outlet and the secondary demist outlet is each surrounded by another seat area.

3. The distribution assembly of claim 2, wherein the primary door body and the secondary door body each include a door seal, each of the door seals are configured to interface with the seat area and the another seat area.

4. The distribution assembly of claim 1, wherein the primary door body and the secondary door body are adjacent to each other and planarly parallel to each other.

5. The distribution assembly of claim 1, wherein the defrost door is rotatably mounted to the distribution case at a door mount.

6. The distribution assembly of claim 1, wherein the door shaft of the defrost door includes a first end, a second end, and an intermediate portion disposed between the first end and the second end, a primary door body and a secondary door body extend to a door body length from the intermediate portion of the door shaft into the air flow path to the defrost outlet, the primary demist outlet, and the secondary demist outlet, the primary door body and the secondary door body have a width that is approximately equal to the portioned width and the demist width combined.

7. The distribution assembly of claim 1, wherein the defrost door is rotatably positioned to be in at least one of a closed position of a zero degree angle, a partial open position of a ten degree angle, another partial open position of a thirty degree angle, and full open position of a forty degree angle.

8. The distribution assembly of claim 7, wherein the defrost door is positioned to be in the closed position, the partial open position, the another partial open position, and the full open position that provides an air distribution ratio between the defrost outlet and the primary demist outlet and the secondary demist outlets.

9. The distribution assembly of claim 8, further including:
a panel outlet with a panel distribution door;
a foot outlet with a foot distribution door; and
a rear outlet with a rear distribution door,
wherein the defrost door, the panel distribution door, the foot distribution door, and the rear distribution door are configured to be opened and closed depending on a mode of the distribution assembly.

10. The distribution assembly of claim 9, wherein the mode of the distribution assembly is at least one of a panel mode, a foot mode, a heat mode, and a defrost mode.

11. The distribution assembly of claim 10, wherein the defrost door is in the closed position in the panel mode, the defrost door is in the partial open position in the foot mode, the defrost door is in the another partial open position in the heat mode, and the defrost door is in the full open position in the defrost mode.

12. A heating, ventilation, and air conditioning (HVAC) unit comprising:
an air intake;
a blower assembly; and
a distribution assembly, the distribution assembly including:
a defrost outlet with a defrost width, the defrost outlet portioned into a primary defrost portion and a secondary defrost portion;
a primary demist outlet and a secondary demist outlet, the primary demist outlet and the secondary demist outlet each have a demist width, the demist width of the primary demist outlet in combination with the a width of the primary defrost portion creates a primary portion width, the demist width of the secondary demist outlet in combination with another width of the secondary defrost portion creates a secondary portion width;
a defrost door including a door shaft, a primary door body, and a secondary door body, the door shaft is rotatably mounted to the distribution assembly, the primary door body having a primary door body width that is approximately equal to the primary portion width, the secondary door body having a secondary door body width that is approximately equal to the secondary portion width, and the primary door body and the secondary door body each extending laterally from the door shaft to a door body length;
a case blocker extending in a direction of an air flow path before the defrost outlet, the case blocker extending to a blocker height, the case blocker having a blocker width that is approximately equal to the primary defrost outlet width and the secondary defrost outlet width combined; and
guiding ribs extending from a face of each of the primary door body and the secondary door body to a guiding rib height, the guiding ribs having a guiding rib length across a portion of each of the primary door body and the secondary door body that is angled from a door body gap that separates the primary door body from the secondary door body to at least one of the primary demist outlet and the secondary demist outlet.

13. The HVAC unit of claim 12, wherein the defrost door is rotatably positioned to be in at least one of a closed position of a zero degree angle, a partial open position of a ten degree angle, another partial open position of a thirty degree angle, and full open position of a forty degree angle.

14. The HVAC unit of claim 13, wherein the defrost door is positioned to be in the closed position, the partial open position, the another partial open position, and the full open position providing an air distribution ratio between the defrost outlet and the primary demist outlet and the secondary demist outlet.

15. The HVAC unit of claim 14, further including:
a panel outlet with a panel distribution door in the distribution assembly;
a foot outlet with a foot distribution door in the distribution assembly; and
a rear outlet with a rear distribution door in the distribution assembly,
wherein the defrost door, panel distribution door, the foot distribution door, and the rear distribution door are configured to be opened and closed depending on a mode of the distribution assembly.

16. The HVAC unit of claim 15, wherein the defrost door is in the closed position in a panel mode, the defrost door is in the partial open position in a foot mode, the defrost door is in the another partial open position in a heat mode, and the defrost door is in the full open position in a defrost mode.

17. A heating, ventilation, and air conditioning (HVAC) comprising:
an air intake;
a blower assembly configured to create an air flow path by a blower motor with a fan, the air flow path beginning at the air intake and flowing to the blower assembly; and
a distribution assembly configured to receive the air along the air flow path after the blower assembly, the distribution assembly including:
a plurality of distribution apertures including a defrost outlet, a primary demist outlet, and a secondary demist outlet, the defrost outlet having a primary defrost outlet width and a secondary defrost outlet width, the primary demist outlet having a primary demist outlet width, the primary demist outlet being adjacent to the defrost outlet and in combination with the primary defrost outlet width creates a primary width, the secondary demist outlet having a secondary demist width, the secondary demist outlet being adjacent to the defrost outlet and in combination with the secondary defrost outlet width creates a secondary width;
a defrost door with a door shaft, a primary door body, and a secondary door body, the door shaft is rotatably mounted to the distribution assembly, the primary door body and the secondary door body extending to a door body length from the door shaft in a direction of the defrost outlet and the primary demist outlet and the secondary demist outlet;
a case blocker extending in a direction of the air flow path before the defrost outlet, the case blocker extending to a blocker height, the case blocker having a blocker width that is approximately equal to the primary defrost outlet width and the secondary defrost outlet width combined; and
guiding ribs extending to a guiding rib height from a face of each of the primary door body and the secondary door body, the guiding ribs having a guiding rib length along the face of each of the primary door body and the secondary door body at an angle from the door body gap to at least one of the primary demist outlet and the secondary demist outlet,
wherein the defrost door is configured to be positioned at an angle by the door shaft, and the case blocker and the guiding ribs of the primary door body and the secondary door body create an air distribution ratio of the air along the air flow path between the defrost outlet and the primary demist outlet and the secondary demist outlet.

18. The HVAC unit of claim 17, further including:
a panel outlet with a panel distribution door in the distribution assembly;
a foot outlet with a foot distribution door in the distribution assembly; and
a rear outlet with a rear distribution door in the distribution assembly,
wherein the defrost door, the panel distribution door, the foot distribution door, and the rear distribution door are configured to be opened and closed depending on a mode of the distribution assembly.

19. The HVAC unit of claim 18, wherein the mode of the distribution assembly is at least one of a panel mode, a foot mode, a heat mode, and a defrost mode.

20. The HVAC unit of claim 19, wherein the defrost door is in a closed position at an angle of approximately zero degrees in the panel mode, the defrost door is in a partial open position at an angle of approximately ten degrees in the foot mode, the defrost door is in another partial open position at an angle of approximately thirty degrees in the heat mode, and the defrost door is in a full open position at an angle of approximately forty degrees in the defrost mode.
